(19) United States
(12) Patent Application Publication
(10) Pub. No.: US 2002/0067041 A1
(43) Pub. Date: Jun. 6, 2002

(54) Compressor air piping system and method

(76) Inventors: James Christopher Collins, Mooresville, NC (US); Paul Harry Adkins, Davidson, NC (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/942,505

(22) Filed: Aug. 30, 2001

Related U.S. Application Data
(60) Provisional application No. 60/228,754, filed on Aug. 30, 2000.

(51) Int. Cl. F16L 25/00

(52) U.S. Cl. 285/386

(57) ABSTRACT

A piping assembly for a compressed air assembly and a method of forming the piping assembly. The piping assembly comprises hollow aluminum tubing having first and second ends. First and second threaded connector members associated with first and second compressed air assembly components. A compression fitting is associated with each end of the aluminum tubing and each compression fitting is configured to sealingly engage a respective one of the threaded connector members.

This application claims the benefit of U.S. Provisional Application No. 60/228,754 filed Aug. 30, 2000.

### BACKGROUND

The present invention relates to air compressors. More particularly, the present invention relates to an air compressor piping system and a method of interconnecting compressed air components.

Historically, compressed air systems have used iron or steel pipe with threaded pipe and fitting members to transport fluid to the point of use. When installing these systems, pipes frequently need to be cut to a custom length and threaded with special tooling. Furthermore, special sealants are often required in joining the threaded pipe to the fittings to make the joint pressure tight. Alternative systems have been made from copper pipe, which typically uses soldered joints, or stainless steel pipe which may require welding. All this work greatly increases the installation time and resources needed to assemble the compressed air system piping.

Over time, the iron, steel and copper pipes typically corrode. Such corrosion often results in a loss of air flow and increased pressure drops. Additionally, corrosion debris can loosen and flow downstream into compressed air components thus contaminating the system and causing potential problems to filters, tools, and other equipment.

### SUMMARY

The present invention relates to a piping assembly for a compressed air assembly. The piping assembly comprises at least a first length of hollow aluminum tubing having first and second ends. A first threaded connector member is adapted to be associated with a first compressed air assembly component and a second threaded connector member is adapted to be associated with a second compressed air assembly component. A compression fitting is associated with each end of the aluminum tubing. Each compression fitting is configured to sealingly engage a respective one of the threaded connector members.

A method of interconnecting members of a compressed air system and a method of forming a piping assembly for a compressed air system are also provided.

### BRIEF DESCRIPTION OF THE DRAWINGS

FIG. 1 is a schematic drawing illustrating a compressed air system utilizing the piping system of the present invention.

FIG. 2 is a side elevational view of a portion of piping of the present invention.

FIG. 3 is an end view of the piping of the present invention along the line 3-3 in FIG. 2.

FIG. 4 is an isometric view of an illustrative pipe bender usable with the preferred piping of the present invention.

### DETAILED DESCRIPTION OF THE PREFERRED EMBODIMENTS

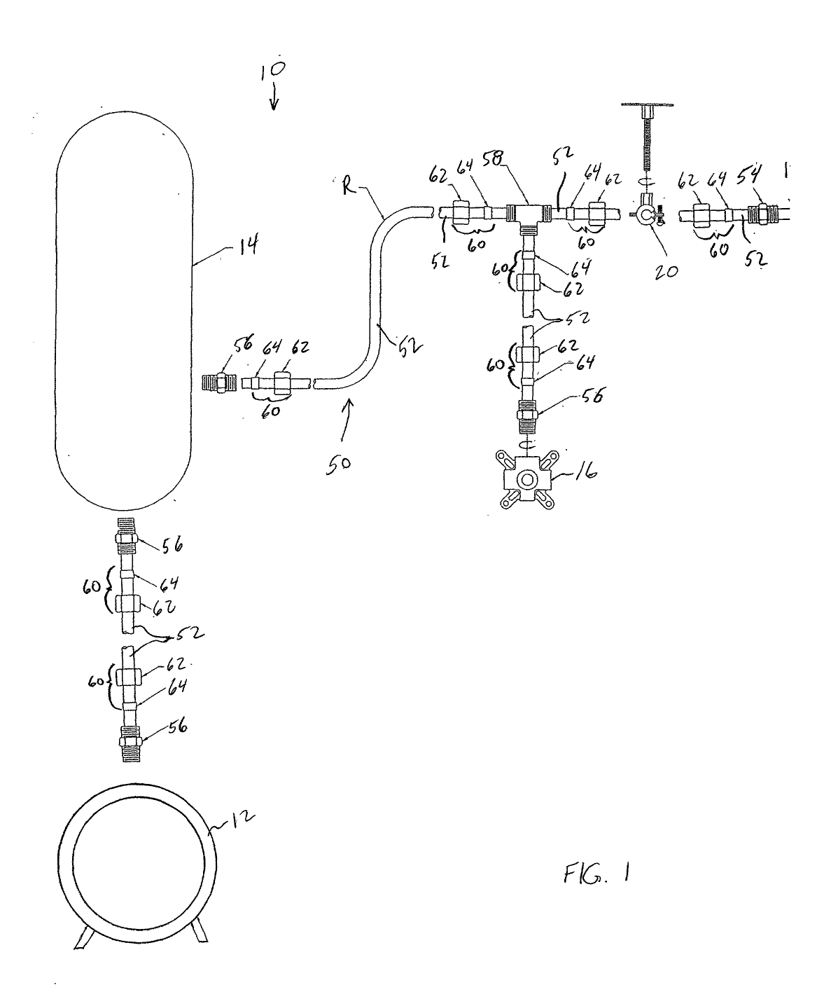

Referring to FIG. 1, an illustrative compressor system 10 incorporating a piping system 50 that is a preferred embodiment of the present invention is shown. The illustrated compressor system 10 includes, for example, a compressor 12, a compressed air storage tank 14, a distribution block 16 for connecting point of use components and a downstream line 18. Other compressor system components may also be used together with or in place of any or all of the illustrated components. The compressor components 12-18 are interconnected utilizing the preferred piping system 50. The piping system 50 includes round aluminum piping 52, various threaded connectors 54-58 and a plurality of compression fittings 60.

The threaded connectors 54-58 can be of numerous configurations. While the system is not limited to the illustrated connectors, the illustrated connectors are briefly described. Unions 54 can be utilized for joining two lengths of piping. A suitable union is available from Ingersoll-Rand Company under part no. 54563861. Straight male studs 56 are generally utilized to interconnect a length of piping to one of the compressor components. A suitable straight male stud is available from Ingersoll-Rand Company under part no. 54563895. Tee unions 58 are utilized to split the piping into multiple branches. A suitable tee union is available from Ingersoll-Rand Company under part no. 54563960. Other connectors, for example, 45° and 90° elbows, may also be used. Additionally, mounting brackets 20 and the like may be utilized to support the piping 52 between the various components.

The piping 52 is interconnected to the threaded connectors 54-58 using compression fittings 60. The preferred compression fittings 60 include a compression nut 62 and a ferrule 64. The piping 52 is inserted into the respective connector 54-58 and the compression nut 62 is tightened over the ferrule 64. As the nut 62 is tightened, the ferrule 64 is pressed into the connector 54-58, causing the ferrule 64 to compress against the piping 52 and the compression nut 62, thereby providing a fluid tight connection. The ferrules 64 may be, but do not have to be, of the bite type. The piping 52 does not require any special preparation, for example, threading, etching or the like, prior to connection. The piping 52 is simply cut to a desired length such that it can be positioned into the desired connector. Additionally, the compression seal created between the ferrule 64, piping 52 and connector 54-58 is extremely reliable and leak free without the use of additional material and process steps (i.e.: applying sealant to threads, soldering, welding, etc.). The fitting materials are chosen to address environmental considerations, for example, thermal expansion, mechanical strength, and atmospheric & galvanic corrosion resistance. A preferred fitting material is nickel plated brass.

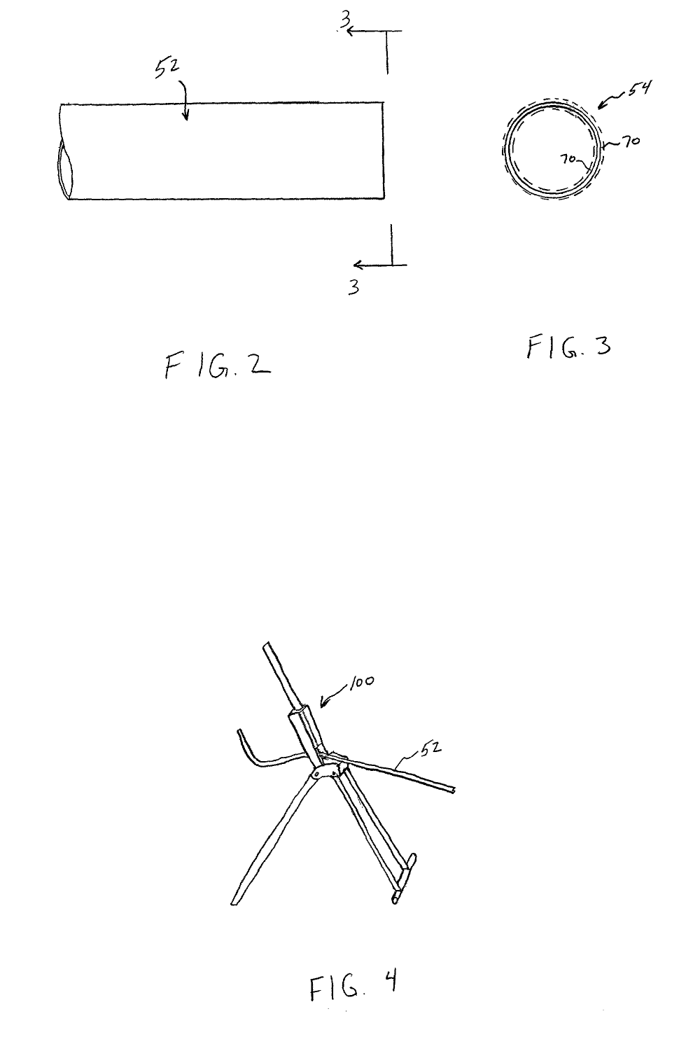

Referring to FIGS. 2 and 3, the preferred piping 52 will be described. The preferred piping 52 is round extruded aluminum tubing. The ductile nature of the aluminum tubing allows the piping 52 to be bent as necessary to accommodate the configuration of a given compressed air assembly 10. The malleable and ductile nature of the aluminum allows the piping 52 to be bent utilizing a pipe bender 100, similar to that shown if FIG. 4, or the like into many smooth radius shapes R, thereby minimizing the need for various types of elbow fittings. Reducing the number of elbow type fittings allows for quicker installation and minimizes the number of potential leak points. The extrusion and the smooth radius bends leave an extremely smooth, continuous surface finish that minimizes the flow losses and pressure drops of the compressed air.

While a ductile tubing is desired, the piping 52 must also have sufficient strength to withstand the forces associated with the compressed air pressure. To provide such, the extruded aluminum tubing is age hardened utilizing a thermal or chemical treatment to increase the strength and hardness of the tubing. The aluminum material and age hardening process are chosen such that the tubing has sufficient strength while maintaining a desired degree of ductility. Many combinations of material and hardening can be utilized to balance these desired attributes. A preferred material and treatment is 6063-T4 as recognized under the Aluminum Association standards, the 6063 designating a specific mixture of aluminum, magnesium and silicon and the T4 designating a solution heat-treated and naturally aged hardening process. One inch tubing manufactured with these parameters and having a 22 mm outside diameter and a wall thickness of approximately 1.5 mm has been found to support working air pressures of at least 250 psi and to permit a smooth 180° bend with an inside radius of 75 mm. Other piping sizes may also be used. The piping 52 is preferably manufactured such that the tubing is bendable to 180° with a minimum bend radius less than four times the outside diameter of the tubing.

To further enhance the piping performance, the preferred piping 52 is anodized along the inside and outside surfaces. The aluminum is immersed in an acid electrolyte bath through which an electrical current is passed. This causes a coating of aluminum oxide 70 to grow on the internal and external surfaces of the aluminum tubing. The coating thickness and surface characteristics can be controlled to meet a desired level of corrosion resistance. The preferred anodization standard is Aluminum Association specification AA-MM32 C11 C22 A213, the MM32 designating a directional sanding, the C11 and C22 designating a chemical degreasing and a medium matte etched finish, and the A213 indicating a film thickness of 0.0003 inches. The aluminum oxide 70 created by the anodizing provides a first, primary boundary of corrosion resistance for the piping 52. Additionally, the aluminum material has a natural corrosion resistance that provides a secondary boundary of corrosion resistance. In an Accelerated Environmental Test performed by Applied Technical Services, Incorporated utilizing a salt spray under method ASTM B117-97, piping manufactured in accordance with the above anodization standard showed no corrosion after 1100 hours while common commercial black steel pipe showed severe red rust after 250 hours under the same conditions.

The piping assembly 50 of the present invention provides piping 52 having a smooth, corrosion resistant surface finish that minimizes flow losses and pressure drops. Additionally, the piping assembly allows extremely reliable, fast and versatile piping configurations.

What is claimed is:

1. A piping assembly for a compressed air assembly, the piping assembly comprising:
a first length of hollow aluminum tubing having first and second ends;
a first threaded connector member adapted to be associated with a first compressed air assembly component;
a second threaded connector member adapted to be associated with a second compressed air assembly component; and
a compression fitting associated with each end of the aluminum tubing and configured to sealingly engage a respective one of the threaded connector members.

2. The piping assembly of claim 1 wherein the aluminum tubing has anodized inside and outside surfaces.

3. The piping assembly of claim 2 wherein the aluminum tubing is anodized under Aluminum Association specification AA-MM32 C11 C22 A213.

4. The piping assembly of claim 1 wherein the aluminum tubing is age hardened.

5. The piping assembly of claim 4 wherein the aluminum tubing is manufactured under Aluminum Association specification 6063-T4.

6. The piping assembly of claim 1 wherein the aluminum tubing has a round cross-section.

7. The piping assembly of claim 1 wherein the aluminum tubing has a given outside diameter and is bendable to 180° with a minimum bend radius less than four times the outside diameter.

8. The piping assembly of claim 7 wherein the aluminum tubing supports a working pressure of 250 psi.

9. The piping assembly of claim 1 wherein each compression fitting comprises a compression nut and a ferrule.

10. The piping assembly of claim 9 wherein the ferrule is of the bite type.

11. The piping assembly of claim 1 wherein the compression fittings are manufactured from nickel plated brass.

12. The piping assembly of claim 1 wherein each threaded connector member is a straight male stud.

13. A compressed air assembly comprising:
first and second compressed air components, each compressed air component having a threaded connector mating member;
a first length of hollow aluminum tubing having first and second ends;
a first threaded connector member configured to mate with the threaded connector mating member of the first compressed air component;
a second threaded connector member configured to mate with the threaded connector mating member of the second compressed air component; and
a compression fitting associated with each end of the aluminum tubing and configured to sealingly engage a respective one of the threaded connector members.

14. The compressed air assembly of claim 13 wherein the aluminum tubing has anodized inside and outside surfaces.

15. The compressed air assembly of claim 14 wherein the aluminum tubing is anodized under Aluminum Association specification AA-MM32 C11 C22 A213.

16. The compressed air assembly of claim 13 wherein the aluminum tubing is age hardened.

17. The compressed air assembly of claim 16 wherein the aluminum tubing is manufactured under Aluminum Association specification 6063-T4.

18. The compressed air assembly of claim 13 wherein the aluminum tubing has a round cross-section.

19. The compressed air assembly of claim 13 wherein the aluminum tubing has a given outside diameter and is bendable to 180° with a minimum bend radius less than four times the outside diameter.

20. The compressed air assembly of claim 19 wherein the aluminum tubing supports a working pressure of 250 psi.

21. The compressed air assembly of claim 13 wherein each compression fitting comprises a compression nut and a ferrule.

22. The compressed air assembly of claim 21 wherein the ferrule is of the bite type.

23. The piping assembly of claim 13 wherein the compression fittings are manufactured from nickel plated brass.

24. The compressed air assembly of claim 13 wherein each threaded connector member is a straight male stud.

25. The compressed air assembly of claim 13 wherein the first compressed air component is a storage tank and the second compressed air component is a distribution block.

26. A method of interconnecting first and second compressed air assembly components, each component having a threaded connector mating member, the method comprising the steps of:
mating a threaded connector member to each of the threaded connector mating members;
providing a length of hollow aluminum piping having first and second ends;
positioning a compression fitting at each end of the piping;
positioning each end of the piping in a respective threaded connector member; and
threadably engaging each compression fitting with a respective threaded connector member.

27. The method of claim 26 further comprises the step of bending the aluminum piping.

28. A method of forming a piping assembly for a compressed air assembly, the method comprising the steps of:
extruding a length of hollow aluminum tubing having a given outside diameter;
age hardening the length of aluminum tubing such that the aluminum tubing supports a minimum air pressure of 250 psi and is bendable to 180° with a minimum bend radius less than four times the outside diameter;
anodizing the aluminum tubing; and
positioning a pair of opposed compression fittings about the hollow aluminum tubing.

29. The method of claim 28 wherein the tubing is age hardened under Aluminum Association specification T4.

30. The method of claim 28 wherein the tubing is anodized under Aluminum Association specification AA-MM32 C11 C22 A213.
